(19) United States
(12) Patent Application Publication
(10) Pub. No.: US 2020/0333669 A1
(43) Pub. Date: Oct. 22, 2020

(54) LCD DEVICE PRODUCTION

(71) Applicant: Flexenable Limited, Cambridge (GB)

(72) Inventor: Patrick Too, Cambridge (GB)

(21) Appl. No.: 16/851,433

(22) Filed: Apr. 17, 2020

(30) Foreign Application Priority Data
Apr. 18, 2019 (GB) 1905514.4

(51) Int. Cl. G02F 1/1337; G02F 1/1341; G02F 1/1333

(52) U.S. Cl. CPC G02F 1/133784; G02F 1/133723; G02F 1/133365; G02F 1/1341

(57) ABSTRACT

A technique comprising: forming a layer of organic polymer liquid crystal alignment material on an organic polymer layer of a first component of a liquid crystal display device; subjecting the layer of liquid crystal alignment material to a unidirectional rubbing treatment that avoids de-adhesion of the layer of liquid crystal alignment material at least in any region of an active display area of the liquid crystal display device; and providing liquid crystal material in contact with the rubbed layer of liquid crystal alignment material and a second unidirectionally-rubbed layer of liquid crystal alignment material on a counter component of the liquid crystal display device.

### CLAIM OF PRIORITY

This application claims priority to Great Britain Patent Application No. 1905514.4, filed Apr. 18, 2019, the content of which is hereby incorporated by reference in its entirety.

### FIELD OF THE INVENTION

There is increasing interest in the use of organic polymer materials in the production of liquid crystal display (LCD) devices. LCD devices comprise liquid crystal (LC) material contained between two components having alignment coatings at the surfaces in contact with the LC material. At least one of the two components includes electrical control circuitry for electrically controlling an optical property of the LC material.

The inventor for the present application is involved in the development of LCD devices that use organic polymer materials for electrically insulating layers, and has noticed an increase in undesirable light leakage in the finished device (comprising polarisation filters on opposite sides of the LC cell) compared to devices that use inorganic insulating materials such as silicon nitrides.

The inventor for the present application has identified the cause of undesirable light leakage as unintended localised de-adhesion of the liquid crystal alignment layer in one or more regions of the active display area of the LCD device.

There is hereby provided a method, comprising: forming a layer of organic polymer liquid crystal alignment material on an organic polymer layer of a first component of a liquid crystal display device; subjecting the layer of liquid crystal alignment material to a unidirectional rubbing treatment that avoids de-adhesion of the layer of liquid crystal alignment material at least in any region of an active display area of the liquid crystal display device; and providing liquid crystal material in contact with the rubbed layer of liquid crystal alignment material and a second unidirectionally-rubbed layer of liquid crystal alignment material on a counter component of the liquid crystal display device.

According to one embodiment, the rubbing treatment comprises rubbing piles of a piled fabric against the layer of alignment material, and setting the distance by which the pile thickness is reduced in the region of closest contact with the layer of alignment material, so as to avoid de-adhesion of the layer of liquid crystal alignment material at least in any region of the active display area of the liquid crystal display device.

According to one embodiment, the method comprises setting the distance by which the pile thickness is reduced in the region of closest contact with the layer of alignment material to about 0.3 mm

According to one embodiment, the alignment material comprises polyimide.

### BRIEF DESCRIPTION OF THE FIGURES

An embodiment of the invention is described hereunder in detail, by way of example only, with reference to the accompanying drawings, in which:

FIG. 1 illustrates the formation of a layer of alignment material on an organic polymer planarisation layer in a first example embodiment;

FIG. 2 illustrates rubbing of the layer of alignment material in the first example embodiment;

FIG. 3 illustrates an example of incorporating the rubbed alignment layer of FIG. 2 in a liquid crystal cell for an LCD device; and

FIGS. 4 and 5 together show the effect of the technique according to the first example embodiment.

### DETAILED DESCRIPTION

In one example embodiment, the technique is used for the production of an organic liquid crystal display (OLCD) device, which comprises an organic transistor device (such as an organic thin film transistor (OTFT) device) for the control component. OTFTs comprise an organic semiconductor (such as e.g. an organic polymer or small-molecule semiconductor) for the semiconductor channels.

The detailed description below makes mention of specific process details (specific materials, etc.) that are not essential to achieving the technical effects described below. The mention of such specific process details is by way of example only, and other specific materials, processing conditions etc. may alternatively be used within the general teaching of the present application.

For example, the detailed description below is for the example of a fringe field switching (FFS) type LCD device, but the same technique is equally applicable to the production of other types of LCD devices, including both other types of LCD devices in which the counter electrode is on the same side of the LC material as the pixel electrode, and types of LCD devices in which the counter electrode is on the opposite side of the LC material to the pixel electrode.

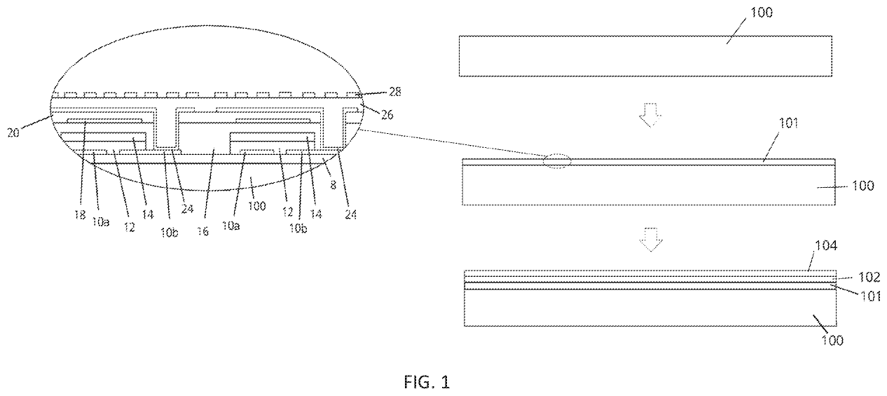

With reference to FIG. 1, a starting workpiece comprises a support component 100. In this example, the support component comprises at least one plastics support film, such as e.g., a cellulose triacetate (TAC) film having a thickness of e.g., about 40 microns.

Processing of the workpiece begins with the formation in situ on the plastics support film component 100 of a plurality of conductor (e.g., metal), organic polymer semiconductor and organic polymer insulator layers (including patterned layers) to form a stack of layers 101 defining an array of pixel electrodes and electrical circuitry for independently addressing each pixel electrode via addressing conductors outside the array of pixel electrodes.

In this example, processing of the workpiece begins with the formation of a hard-coat organic polymer planarisation layer 8 (e.g., epoxy-based cross-linked polymer known as SU-8) in situ on the plastics support film component 100. In this example, the planarisation layer 8 is formed by a liquid processing technique comprising: depositing a liquid film (solution/dispersion of the planarisation material) on the upper surface of the workpiece by e.g., spin-coating; drying the liquid film to solidify the liquid film; and subjecting the solidified film to one or more further treatments such as UV-exposure and subsequent baking to achieve cross-linking.

A source-drain conductor pattern 10a, 10b is formed in situ on the upper surface of the planarisation layer 8. In this example, the formation of a source-drain conductor pattern in situ on the upper surface of the planarisation layer 8 comprises depositing a layer of conductor material or a conductor stack comprising one or more of layers of conductor material on the upper surface of the planarisation layer 8 by a vapour deposition technique such as sputtering, and then patterning the conductor layer/stack by a photolithographic process.

For simplicity, FIG. 1 shows only parts of the source-drain conductor pattern 10a, 10b that form source-drain electrodes defining the channel length of the semiconductor channels of the transistors, but the source-drain conductor pattern may comprise additional parts such as addressing lines that extend from the electrode parts to outside the display area. For the example of the transistors forming an active matrix addressing circuit for the LCD device, the source-drain conductor pattern may comprise (i) an array of source conductors each providing the source electrodes for a respective row of transistors, and each extending to a region outside the display area; and (ii) an array of drain conductors each providing the drain conductor for a respective transistor.

A self-assembled monolayer (SAM) of an organic injection material is then formed selectively on the source/drain conductor pattern. In this example, the SAM comprises an organic material that bonds selectively to the upper metallic surface of the source/drain conductor pattern by e.g., gold-thiol bonds or silver-thiol bonds, without substantially any bonding to the planarisation layer. This SAM further facilitates the transfer of charge carriers between the source-drain conductors and the organic semiconductor material 12 mentioned below.

A patterned stack of organic semiconductor and organic polymer dielectric layers 12, 14 is thereafter formed in situ on the new upper surface of the workpiece. In this example, the formation of this patterned stack comprises: (i) depositing a liquid film (solution/dispersion of the organic semiconductor material) on the upper surface of the workpiece by e.g., spin-coating, drying the liquid film to solidify the liquid film, and baking the solidified film; (ii) depositing a liquid film (solution/dispersion of the polymer dielectric material) on the upper surface of the baked organic semiconductor film by e.g., spin-coating, drying the liquid film to solidify the liquid film, and baking the solidified film; and (iii) creating substantially the same pattern in both layers using a photolithographic technique and reactive ion etching. The pattern comprises an array of isolated islands, each island providing the semiconductor channel for a respective transistor.

A layer 16 of organic polymer dielectric material (exhibiting a higher dielectric constant (k) than the underlying dielectric layer 14) is formed in situ on the new upper surface of the workpiece. In this example, the layer 16 of high-k dielectric material is formed in situ on the workpiece by a process comprising: depositing a liquid film (solution/dispersion of the high-k dielectric material) on the upper surface of the workpiece by e.g., spin-coating, drying the liquid film to solidify the liquid film, and baking the solidified film. This is followed by the formation, in situ on the surface of the baked high-k dielectric layer, of a gate conductor pattern 18. In this example, the gate conductor pattern is formed in situ on the workpiece by a process comprising: forming a conductor layer (or a stack of conductor layers) on the workpiece by a vapour deposition technique such as sputtering; and patterning the conductor layer/stack by a photolithographical technique. In this example, the stack of layers 101 formed in situ on the plastics film component 100 define an active matrix addressing circuit, and the gate conductor pattern 18 comprises an array of gate conductors each providing the gate electrode for a respective column of transistors, and each extending to a region outside the active display area. Each transistor in the active matrix array is associated with a respective unique combination of gate and source conductors, whereby each transistor can be independently addressed via parts of the gate and source conductors outside the active display area.

One or more layers of organic polymer insulating material 20 are formed in situ on the new upper surface of the workpiece. In this example, the one or more insulating layers 20 are formed in situ on the upper surface of the workpiece by a process comprising: depositing a liquid film (solution/dispersion of the insulating material) on the upper surface of the workpiece by e.g., spin-coating, drying the liquid film to solidify the liquid film, and baking the solidified film.

The upper surface of the workpiece is thereafter patterned to create an array of via holes, each via hole extending down to a respective drain conductor 10b. In this example, this patterning comprises: forming in situ on the upper surface of the workpiece a patterned photoresist mask covering all regions of the upper surface of the workpiece except in the regions where the via holes are to be formed; exposing the workpiece to a reactive ion etching (RIE) plasma that etches the insulating layer 20 and upper gate dielectric layer 16; and removing the photoresist mask to again expose the upper surface of the insulating layer 20.

A pixel electrode pattern 24 is then formed in situ on the new upper surface of the workpiece. The pixel electrode pattern defines an array of isolated pixel electrodes, each contacting a respective drain conductor 10b via a respective via hole. In this example, the pixel electrode pattern 24 is formed in situ on the workpiece by a process comprising: forming a conductor layer or stack of conductor layers in situ on the workpiece by a vapour deposition technique such as sputtering; and patterning the conductor layer/stack by a photolithographic technique.

A further polymer insulating layer 26 (or stack of further polymer insulating layers) is formed in situ on the new upper surface of the workpiece. In this example, the insulating layer/stack is formed in situ on the workpiece by a process comprising: depositing a liquid film (solution/dispersion of the polymer insulating material) on the upper surface of the workpiece by e.g., spin-coating, drying the liquid film to solidify the liquid film, and baking the solidified film.

A common electrode pattern 28 is formed in situ on the upper surface of the further insulating layer 26. In this example, the in situ formation of the common electrode pattern comprises: forming a conductor layer or a stack of conductor layers in situ on the upper surface of the further insulating layer 26 by a vapour deposition technique such as sputtering; and patterning the conductor layer/stack in situ on the workpiece by a photolithographic technique.

An organic polymer planarisation layer 102 is formed in situ on the upper surface of the stack 101 (i.e., on the new upper surface of the workpiece). In this example, the planarisation layer 102 comprises a epoxy-based cross-linked organic polymer known as SU-8, and the in situ formation of the planarisation layer comprises: depositing a liquid film (solution/dispersion comprising a precursor to the cross-linked polymer) on the upper surface of the workpiece by e.g., spin-coating; drying the liquid film to solidify the liquid film; and treating the solidified film, by e.g., UV exposure and baking, to achieve cross-linking. The new upper surface of the workpiece is then subjected to a plasma treatment (comprising a plasma generated from a gas or gas mixture including one or more of oxygen, argon, krypton and nitrogen) or a UV Ozone or Deep UV treatment to improve the adhesion between the planarisation layer and the LC alignment layer 104 to be formed in situ on the planarisation layer 102. In this example, the in situ formation of the LC alignment layer 104 on the planarisation layer 102 comprises: depositing a liquid film (solution/dispersion of the alignment material, e.g., polyimide) on the upper surface of the workpiece by e.g. spin-coating; drying the liquid film to solidify the liquid film; baking the solidified film; and physically rubbing the baked film in a single direction.

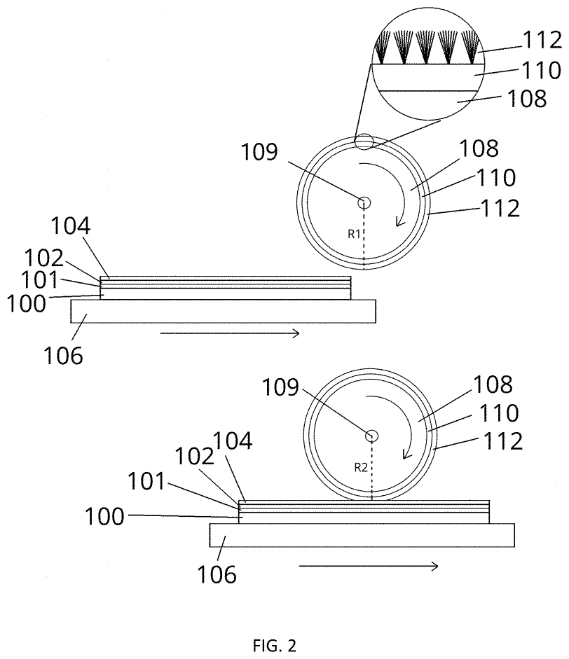

With reference to FIG. 2, the rubbing in this example embodiment uses a rubbing machine comprising a cylindrical roller 108 rotatable about an axis 109 and supporting a rubbing cloth (110, 112). The rubbing cloth is a piled fabric comprising a base fabric 110 and piles 112 extending outwards from the base fabric 110. Each pile 112 comprises a plurality of e.g., nylon filaments. The piles 112 may extend substantially perpendicularly from the base fabric 110, or may be at an angle less than 90 degrees to the plane of the base fabric 110)

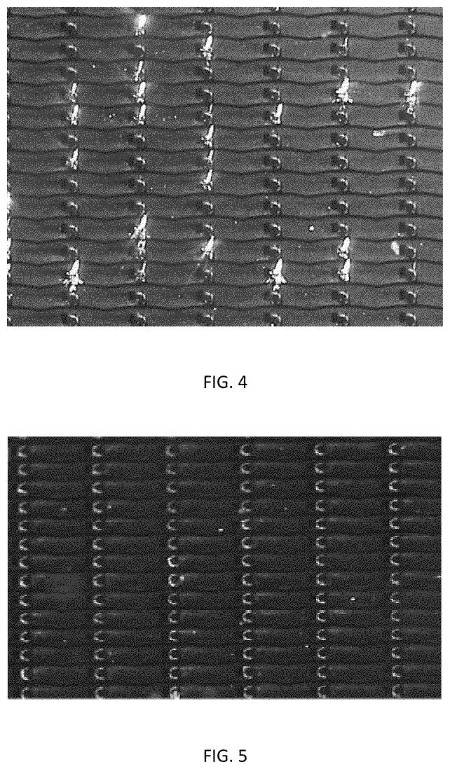

The completed control component comprising the layer of alignment material 104 is mounted on a stage 106 of the rubbing machine. The stage is used to linearly move the control component in one direction while rotating the rubbing cloth in the opposite direction, with the piles 112 of the rubbing cloth in contact with the layer of alignment material 104. The distance (the difference between R1 and R2 in FIG. 2, wherein R1 is the distance between the axis of rotation of the roller 108 and the outer surface of the piles 112 before pressing the piles 112 against the layer of alignment material 104, and R2 is the distance between the axis of rotation of the roller 108 and the upper surface of the layer of alignment material 104 during the rubbing process) by which the pile thickness is reduced in the region of closest contact with the layer of alignment material 104 during rubbing (which is hereafter referred to as the “pile impression”) is set at a level (that is determined by experimentation) to avoid de-adhesion of the polyimide alignment layer 104 from the underlying organic planarisation layer in at least any region of the active display area. FIGS. 4 and 5 show how de-adhesion of the polyimide alignment layer 104 from the organic polymer planarisation layer 102 was avoided by reducing the pile impression from 0.8 mm (FIG. 4) to 0.3 mm (FIG. 5).

The rubbing is observed to produce substantially parallel nanoscale grooves in the layer of alignment material 104, and the liquid crystal alignment action of the rubbed layers is attributed to these nanoscale grooves.

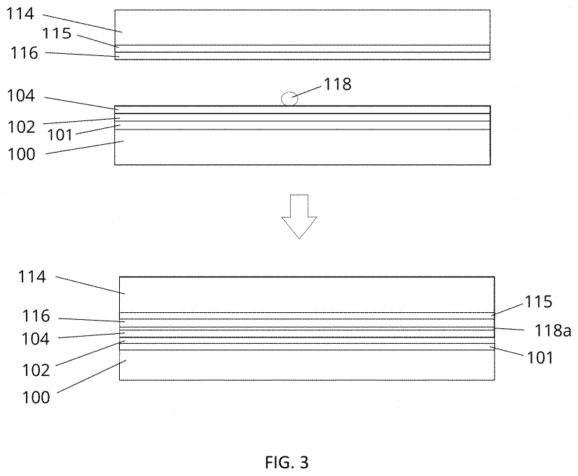

With reference to FIG. 3, a counter component is prepared comprising at least another support component coated with another LC alignment layer. In this example, the counter component also comprises a plastic film component 114 defining an array of colour filters component, an organic polymer planarisation layer 115 (e.g., cross-linked polymer SU-8) formed in situ on the plastics film component 114, and an LC alignment layer 116 produced by the same rubbing technique as described above for the control component. The control component and counter component are laminated together via spacing structures (either forming part of one or more of the control component and counter component, or separate structures such as spacing balls) to achieve a precisely determined separation distance between the two components. Liquid crystal material 118 is introduced into between the two components e.g. at the time of laminating the two components together, or after laminating the two components together, for contact with both the alignment layers 104, 116. The LC alignment layers 104, 116 on opposite sides of the thickness of LC material 118a determine the director (orientation of the LC molecules) of the LC material in each pixel region in the absence of an overriding electric field generated by a voltage between the respective pixel electrode 24 and counter electrode 28. In this example, a change in electric potential at a pixel electrode can change the degree to which the LC material in the respective pixel region rotates the polarisation of polarised light, and thereby can change the transmittance of light in the respective pixel region through the combination of two polarisation filters (not shown) on opposite sides of the LC cell. As mentioned above, each pixel electrode 24 is in contact with the drain conductor 10b of a respective transistor; and the electric potential at each pixel electrode (relative to the electric potential at the counter electrode 28) is independently controllable via parts of the source and gate conductors outside the active display region.

In this example, a one-drop fill (ODF) technique is used to form a substantially uniform thickness of LC material between the two LC alignment layers on the two components. A drop of LC material 118 having at least sufficient volume to create a layer of the desired thickness over the active area of the display device is provided on one of the two LC alignment layers 104, 116. Liquid, curable adhesive is also applied to one or both components outside the active display area, and the two components are forcibly pressed together under vacuum, by which the LC material 118 becomes spread over at least the active display area of the device, followed by curing of the curable adhesive while the two components pressed together. The necessary spacing between the two components (and thus the necessary thickness of LC material 118a, which will depend on the type of LCD device) is ensured by e.g. spacing structures forming an integral part of one or both of the two components beneath the LC alignment layer(s) 104, 116, or separate spacing balls mixed in with the liquid, curable adhesive.

As mentioned above, an example of a technique according to the present invention has been described in detail above with reference to specific process details, but the technique is more widely applicable within the general teaching of the present application. Additionally, and in accordance with the general teaching of the present invention, a technique according to the present invention may include additional process steps not described above, and/or omit some of the process steps described above.

In the example described above, the control and counter components comprise plastics support films, but the technique is equally applicable to better preventing light leakage in liquid crystal devices comprising the same combination of organic polymer liquid crystal alignment layer and underlying organic polymer planarisation layer supported on other types of substrates.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

What is claimed is:

1. A method, comprising:
forming a layer of organic polymer liquid crystal alignment material on an organic polymer layer of a first component of a liquid crystal display device;
subjecting the layer of liquid crystal alignment material to a unidirectional rubbing treatment that avoids de-adhesion of the layer of liquid crystal alignment material at least in any region of an active display area of the liquid crystal display device; and
providing liquid crystal material in contact with the rubbed layer of liquid crystal alignment material and a second unidirectionally-rubbed layer of liquid crystal alignment material on a counter component of the liquid crystal display device.

2. The method according to claim 1, wherein the rubbing treatment comprises rubbing piles of a piled fabric against the layer of alignment material, and setting the distance by which the pile thickness is reduced in the region of closest contact with the layer of alignment material, so as to avoid de-adhesion of the layer of liquid crystal alignment material at least in any region of the active display area of the liquid crystal display device.

3. The method according to claim 2, comprising setting the distance by which the pile thickness is reduced in the region of closest contact with the layer of alignment material to about 0.3 mm

4. The method according to claim 1, wherein the alignment material comprises polyimide.
